(19) United States
(12) Patent Application Publication
(10) Pub. No.: US 2016/0182641 A1
(43) Pub. Date: Jun. 23, 2016

(54) NETWORK OF MEASUREMENT DEVICES COMMUNICATING BY RADIO LINK

(71) Applicant: Commissariat à l'Energie Atomique et aux Energies Alternatives, Paris (FR)

(72) Inventors: Mickael MAMAN, Grenoble (FR); Antoine ROBINET, Tullins (FR); Andrea VASSILEV, Fontaine (FR)

(21) Appl. No.: 14/977,826

(22) Filed: Dec. 22, 2015

(30) Foreign Application Priority Data
Dec. 22, 2014 (FR) 1463118

(51) Int. Cl. H04L 29/08; H04L 12/707; H04B 7/155; H04W 52/18

(52) U.S. Cl. CPC H04L 67/125; H04W 52/18; H04L 45/24; H04B 7/155; H04W 84/18

(57) ABSTRACT

A system including: a centralization unit; and a plurality of detection and/or measurement devices, each device including a radio module capable of communicating with the centralization unit, and a sensor different from the radio module, capable of measuring a physical quantity representative of a variation of the environment of the device, wherein each device is capable of adjusting at least one configuration parameter of its radio module by taking into account a measurement performed by its sensor.

This application claims the priority benefit of French Patent application number 14/63118, filed on Dec. 22, 2014, the contents of which is hereby incorporated by reference in its entirety to the maximum extent allowable by law.

### BACKGROUND

The present disclosure relates to networks of measurement and/or detection devices, and particularly of measurement and/or detection devices capable of communicating over a radio link. It more particularly relates to a smart traffic or parking management system comprising such a network. It may however, more generally, have applications in other fields, as will be explained in further detail at the end of the present disclosure.

### DISCUSSION OF THE RELATED ART

Traffic of parking management systems comprising a plurality of vehicle detection devices deployed in a coverage area, for example embedded in a roadway or under parking spaces, each device being capable of communicating over a radio link with a centralization unit, have already been provided, for example in patent applications US20020190856, US20120161987, and US2006010910.

Systems of this type have various applications. For example, a parking management system may enable to inform in real time a user as to the availability or not of a parking space, or to directly guide him/her towards a free space. In the case of a traffic management system, the system may be capable of informing in real time the users as to the density of the detected traffic, for example, to calculate travel times and/or to suggest alternative routes.

Detection devices deployed in the ground are generally self-contained devices, powered by batteries, each device for example comprising a vehicle sensor and a radio communication unit. Because battery replacement operations are relatively complex and expensive, there is a need to optimize the power consumption of these devices, while preserving or improving the robustness of radio links with the centralization unit.

### SUMMARY

To achieve this, an embodiment provides a system comprising: a centralization unit; and a plurality of detection and/or measurement devices, each device comprising a radio module capable of communicating with the centralization unit, and a sensor different from the radio module, capable of measuring a physical quantity representative of a variation of the environment of the device, wherein each device is capable of adjusting at least one configuration parameter of its radio module while taking into account a measurement performed by its sensor.

According to an embodiment, the parameter is a parameter from the group comprising: the transmit power of the radio module; the receive sensitivity of the radio module; the transmission rate of the radio module; the transmit carrier frequency of the radio module; the directivity of the antenna of the radio module; and the routing path of communications between the radio module and the centralization unit.

According to an embodiment, in each device, the sensor is a magnetic field sensor.

According to an embodiment, each device is capable of performing said adjustment before the beginning of a phase of radio communication between the device and the centralization unit.

According to an embodiment, in each device, the radio module has an adjustable transmit power.

According to an embodiment, the network formed by the devices and the centralization unit has a topology such that there exists a plurality of possible routing paths for the communications between each device and the centralization unit, and each device may be set to select a specific routing path for its communications with the centralization unit.

According to an embodiment, the system further comprises at least one repeater capable of relaying communications between a device and the centralization unit.

According to an embodiment, each device comprises a unit for controlling its sensor and its radio module, and for processing the data provided by its sensor.

According to an embodiment, each device comprises an electric battery for its power supply.

According to an embodiment, each device is capable of deciding whether to postpone or not a radio communication by taking into account a measurement performed by its sensor.

Another embodiment provides applying a system of the above-mentioned type to motor vehicle traffic or parking management, the sensor of each device being a vehicle sensor.

According to an embodiment, the devices are intended to be embedded in the ground, for example under a roadway or under parking spaces.

Another embodiment provides a method of setting the radio module of a detection and/or measurement device comprising a radio module capable of communicating with a centralization unit external to the device, and a sensor different form the radio module capable of measuring a physical quantity representative of a variation of the environment of the device, this method comprising the steps of: reading an output value of the sensor; and adjusting at least one configuration parameter of the radio module by taking into account said output value of the sensor.

According to an embodiment, the parameter is a parameter from the group comprising: the transmit power of the radio module; the receive sensitivity of the radio module; the transmission rate of the radio module; the transmit carrier frequency of the radio module; the directivity of the antenna of the radio module; and the routing path of communications between the radio module and the centralization unit.

The foregoing and other features and advantages will be discussed in detail in the following non-limiting description of specific embodiments in connection with the accompanying drawings.

### BRIEF DESCRIPTION OF THE DRAWINGS

FIG. 1 schematically shows an example of topology of a traffic or parking management system;

FIG. 2 schematically shows another example of topology of a traffic or parking management system;

FIG. 3 schematically shows in the form of blocks an example of an embodiment of a vehicle detection device of a traffic or parking management system; and

FIG. 4 schematically shows in the form of blocks an embodiment of a method of controlling a vehicle detection device of a traffic or parking management system.

### DETAILED DESCRIPTION

For clarity, the same elements have been designated with the same reference numerals in the different drawings. Further, only those elements which are useful to the understanding of the embodiments have been detailed.

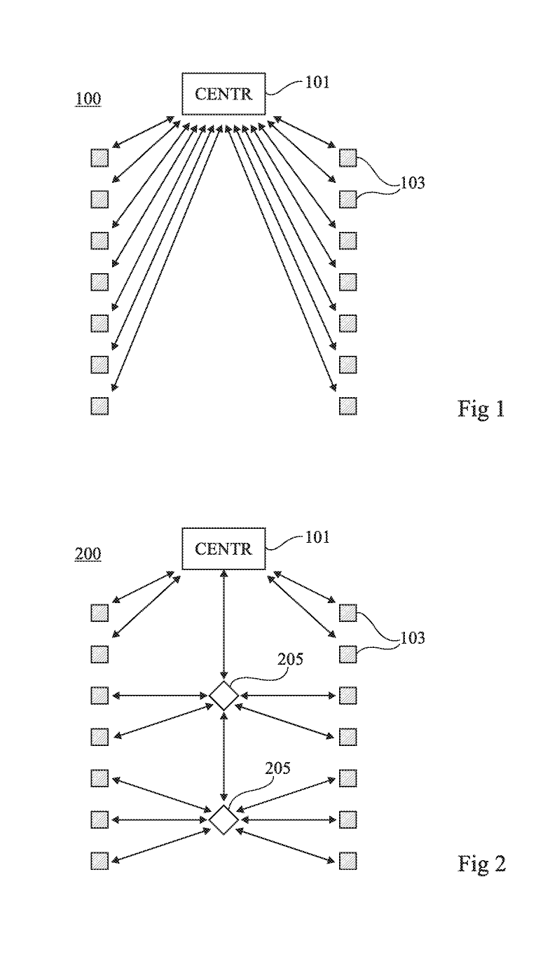

FIG. 1 schematically shows an embodiment of a traffic or parking management system 100. System 100 of FIG. 1 comprises a centralization unit 101 (CENTR), and a plurality of vehicle detection devices 103 capable of communicating over a radio link with centralization unit 101.

Centralization unit 101 comprises a radio transceiver unit and is capable of coordinating the communications with devices 103 and of collecting and centralizing the data transmitted by devices 103. As an example, centralization unit 101 is connected to a local station (not shown) centralizing the communications with a plurality of units 101, the local station being itself connected to a central server (not shown), centralizing the communications with a plurality of local stations. Centralization unit 101 may be powered by a permanent electric power source, for example, a conventional electric power distribution network.

Each device 103 comprises a sensor capable of measuring a physical quantity representative of the presence or not of a vehicle in the vicinity of the device, and a radio transceiver unit capable of communicating with centralization unit 101. Devices 103 are self-contained devices, that is, not connected to an external electric power distribution network. As an example, each device 103 comprises, for its power supply, an electric battery possibly coupled with a power recovery device.

In the example of FIG. 1, centralization unit 101 and detection devices 103 form a network having a star-shaped topology, that is, each detection device 103 can only directly communicate with centralization unit 101. In particular, a direct communication between two detection devices 103 is not possible.

As an example, each device 103 may be configured to periodically perform measurements by means of its vehicle sensor, and to initiate a communication with centralization unit 101 each time it detects a specific event such as the arrival of a vehicle in the vicinity of device 103, or the leaving of a vehicle, to inform unit 101 of this event. As a variation or as a complement, each device 103 may be configured to periodically perform measurements by means of its vehicle sensor at a first frequency, for example every 1 to 5 seconds, and to periodically communicate with centralization unit 101 at a second frequency lower than the first frequency, for example, every 1 to 5 minutes, to transmit thereto data acquired by its vehicle sensor.

FIG. 2 schematically shows another embodiment of a traffic or parking management system 200. System 200 of FIG. 2 comprises structural and functional elements common with system 100 of FIG. 1. Only the differences between system 200 of FIG. 2 and system 100 of FIG. 1 will be detailed hereafter.

System 200 of FIG. 2 differs from system 100 of FIG. 1 mainly by the topology or the architecture of the network comprising centralization unit 101 and vehicle detection devices 103.

In addition to centralization unit 101 and detection devices 103, system 200 of FIG. 2 comprises one or a plurality of repeaters 205. Each repeater 205 comprises a radio transceiver unit and is capable of relaying the communications between centralization unit 101 and detection devices 103. Each repeater 205 may be powered with a permanent external electric power source, for example, a conventional electric power distribution network, or with a battery. As a variation, each repeater 205 may be associated with a detection device 103 and may be powered by the same battery as device 103. In other words, a repeater may be a detection device 103 integrating an additional communication relay function.

In the example of FIG. 2, centralization unit 101, detection devices 103, and repeaters 205 form a network having a partially connected mesh topology, that is, each detection device 103 can only directly communicate with centralization unit 101 or with repeaters 205. Repeaters 205 especially enable to increase the network coverage and to improve the robustness of communications.

A difference between system 200 of FIG. 2 and system 100 of FIG. 1 is that, in system 200 of FIG. 2, there exists a plurality of routing paths between each detection device 103 and centralization unit 101.

The described embodiments are not limited to the examples described in relation with FIGS. 1 and 2 of topologies of the network comprising centralization unit 101 and vehicle detection devices 103. More generally, the described embodiments apply to any types of network topologies. As an example, the network may have a tree topology, that is, where each device 103 is capable of directly communicating only with a node of higher rank formed by another device 103, or of centralization unit 101 which defines the top of the tree structure. As a variation, the network may have a fully connected mesh topology, that is, each device 103 may directly communicate with any other device 103 of the network (each device 103 then integrates a repeater or a relay function).

A problem which is posed in traffic or parking management systems is that radio connections between detection devices 103 and centralization unit 101 are likely to be strongly disturbed by the presence of vehicles.

To limit risks of disconnection, detection devices 103 emitting high powers may be provided. However, this causes a high electric power consumption by devices 103, thus decreasing the autonomy thereof.

To increase the autonomy of detection devices 103, each device 103 may have an adjustable transmit power. Each device 103 may then be configured, at the beginning of a communication with centralization unit 101, to measure, via its radio module, an indicator of the quality of the radio connection, and then accordingly adjust its transmit power. To achieve this, device 103 may for example:
transmit for a first time at its maximum transmit power to initiate the communication with unit 101;
measure, via it radio module, a quantity representative of the power of the signal transmitted in return by unit 101, for example, an indicator of the type generally called RSSI (“Received Signal Strength Indication”) in the art; and then
if the quality of the radio link is sufficient, decrease its transmit power for the rest of the communication.

However, a disadvantage is that the adjustment of the transmit power is only performed after a first non-optimized exchange with centralization unit 101, performed at the maximum transmit power of device 103. This results in a relatively high electric power consumption.

Further, in the case where the network comprising detection devices 103 and centralization unit 101 has a topology such that there exists a plurality of possible communication routing paths between each device 103 and unit 101, each device 103 may be configured to, at the beginning of a communication with centralization unit 101, measure, via its radio module, an indicator of the quality of the radio link for a first routing path (for example, the shortest path or the last path used) and, if the quality of the link if insufficient, select another routing path. To achieve this, device 103 may for example:
transmit for a first time via a first routing path to initiate the communication with unit 101;
measure, via it radio module, a quantity representative of the power of the signal transmitted in return by unit 101, for example, an RSSI-type indicator; and then
if the quality of the link is not sufficient, select another routing path.

However, a disadvantage is that the adjustment of the routing path requires a first non-optimized exchange with centralization unit 101, which causes a relatively high power consumption and/or problems of communication reliability.

An aspect of an embodiment provides a traffic or parking management system where each vehicle detection device 103 is capable of adjusting at least one configuration parameter of its radio module by taking into account a measurement performed by its vehicle sensor.

As an example, the radio parameters adjusted by device 103 may be selected from among the following:
the transmit power of its radio module (if this power is adjustable);
the receive sensitivity of its radio module (if this sensitivity is adjustable);
the rate of data transmission by its radio module (if this rate is adjustable);
the transmit carrier frequency of its radio module (if this frequency is adjustable);
the directivity of the antenna of its radio module (if this directivity is adjustable); and
the routing path of communications between its radio module and centralization unit 101 (if the network comprising detection devices 103 and centralization unit 101 has a topology such that there exists a plurality of routing paths between device 103 and unit 101).

The inventors have indeed observed that the measurements performed by the vehicle sensor of a vehicle detection device 103 are representative of the quality of the radio link between this device and centralization unit 101. Indeed, the measurements performed by the vehicle sensor enable to determine whether a vehicle is capable of disturbing the communication between device 103 and unit 101. It is thus here provided, before starting a communication between device 103 and centralization unit 101, to adjust the radio communication parameters of device 103 by taking into account the measurements provided by its vehicle sensor.

Thus, each device 103 may, before the beginning of a communication with centralization unit 101, measure, via its vehicle sensor, a physical quantity representative of the presence or not of a vehicle in the vicinity of the device, and accordingly adjust one or a plurality of parameters of its radio module.

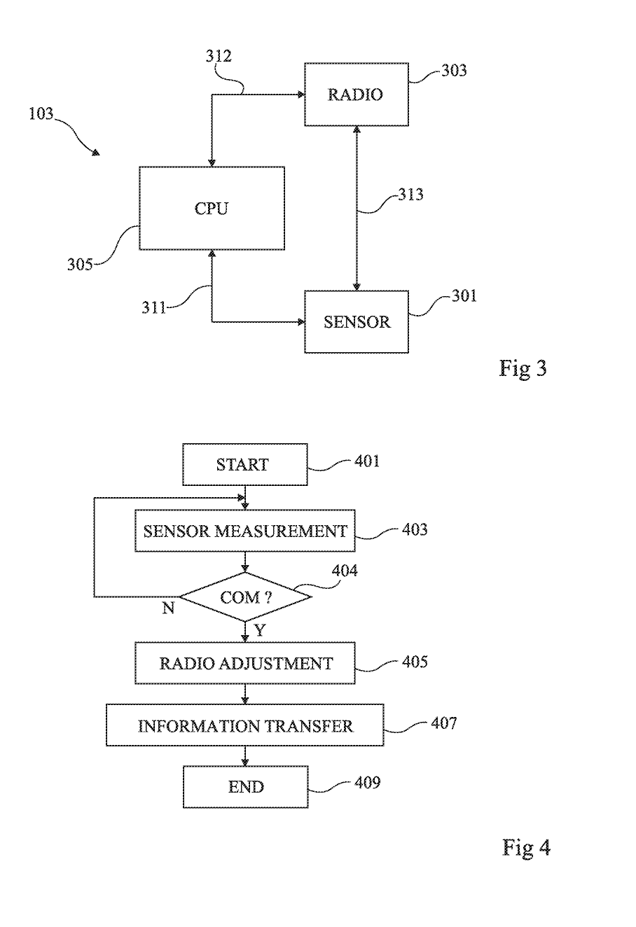

FIG. 3 schematically shows, in the form of blocks, an embodiment of a vehicle detection device 103 of a traffic or parking management system.

In this example, device 103 comprises at least one sensor 301 (SENSOR) capable of measuring a physical quantity representative of the presence or not of a vehicle in the vicinity of device 103. Sensor 301 is preferably a magnetometer. A study conducted by the inventors has indeed shown that there exists a strong correlation between the intensity of the magnetic field in the vicinity of detection device 103, and the RSSI indicator of the quality of the radio link between device 103 and unit 101. More particularly, when the intensity of the measured magnetic field increases, the indicator (RSSI) of the power received by device 103 decreases, and conversely. The described embodiments are however not limited to this specific case. As a variation, sensor 301 may be an ultrasound sensor, an optical sensor, or any other sensor capable of detecting the presence of a vehicle.

Device 103 further provides a radio transceiver unit 303 (RADIO) capable of communicating with centralization unit 101. Unit 303 comprises means for adjusting its transmit power, and/or means for adjusting its receive sensitivity, and/or means for adjusting its data transmission rate; and/or means for adjusting its transmit carrier frequency; and/or means for adjusting the directivity of its antenna; and/or means for adjusting the routing path of its communications with centralization unit 101.

Device 103 further comprises a control and processing unit 305 (CPU), for example, a microprocessor or any other adapted circuit, connected to sensor 301 and to radio module 303 as schematically illustrated by arrows bearing reference numerals 311 and 312 in FIG. 3. Unit 305 is capable of controlling the acquisition of measurements by sensor 301, and of receiving measurement values provided by sensor 301. Unit 305 is further capable of controlling radio module 303 to transmit data towards centralization unit 101, for example, measurements performed by sensor 301, or data determined from measurements performed by sensor 301. Unit 305 is further capable of adjusting the above-mentioned adjustable parameters of radio module 303, by taking into account the measurements performed by sensor 301.

As a variation, sensor 301 is directly connected to radio module 303, as schematically illustrated by the arrow bearing reference numeral 313 in FIG. 3. Radio module 303 is then capable of receiving measurements provided by sensor 301, and of transmitting corresponding data towards centralization unit 101. Radio module 303 is further capable of adjusting at least one of the above-mentioned adjustable parameters by taking into account the measurements performed by sensor 301.

FIG. 4 schematically shows in the form of blocks an example of a method of controlling vehicle detection device 103 of FIG. 3. FIG. 4 more particularly shows the development of a phase of measurement or detection and data transmission from device 103 to centralization unit 101 of the traffic or parking management system.

At a step 401 (START), a phase of measurement or detection and data transmission is initiated by device 103.

At a step 403 (SENSOR MEASUREMENT), an output value of sensor 301 is acquired by device 103.

At a step 404 (COM?) subsequent to step 403, device 103 determines, for example, by taking into account the value read at step 403, whether data should be communicated to centralization unit 101. If no communication should be performed, step 403 and then step 404 may be repeated, possibly after a waiting time.

If a communication is to be performed, after step 403 and before the beginning of the actual radio communication between device 103 and centralization unit 101, a step 405 (RADIO ADJUSTMENT) of adjustment of at least one of the above-mentioned configuration parameters of radio module 303 by taking into account the output value of sensor 301 acquired at step 403 is implemented.

At a step 407 (INFORMATION TRANSFER) subsequent to step 405, the actual radio communication between device 103 and centralization unit 101 is implemented, by using the adjustment of radio module 303 determined at step 405.

The data transmission phase ends at a step 409 (END) subsequent to step 407.

An advantage of the described embodiments is that the radio communication parameters of device 103 may be adjusted according to the radio link quality, even before the initialization of the radio communication between device 103 and centralization unit 101. This results in a decrease in the electric power consumption of device 103 and/or in an improvement of the robustness of communications, as compared with systems where the adjustment of the radio communication parameters requires a first “non-optimized” data exchange between device 103 and centralization unit 101.

It should be noted that the adjusting of the radio parameters only based on the data provided by the vehicle sensor is all the more advantageous as the electric power consumption of the sensor is generally low as compared with the electric power consumption of the radio module.

Specific embodiments have been described. Various alterations, modifications, and improvements will occur to those skilled in the art. In particular, to further improve the energetic balance of communications between vehicle detection devices 103 and centralization unit 101, each device 103 may, by taking into account the measurements performed by its vehicle sensor, decide to postpone a radio communication to a time likely to be more favorable in terms of reliability and of energy balance of the communication. As an example, in the case of a traffic management system, device 103 may wait for a previously-detected vehicle to leave to transmit to centralization unit 101 information relative to the passing of this vehicle, in order to avoid for the communication to be disturbed by the vehicle.

Further, although an embodiment applied to a traffic or parking management system where devices 103 are vehicle detection devices has been detailed hereabove, the described embodiments are not limited to this specific application. The provided solution may more generally have applications in other systems using a network of detection or measurement devices capable of communication by radio link. As an example, devices 103 may be temperature and/or humidity rate measurement devices installed in a home, a factory, an outdoor environment, etc. Each device 103 then comprises a temperature sensor and/or a humidity rate sensor, and the radio module of the device may be adjusted according to the temperature and/or humidity rate values measured by the sensor. More generally, the described embodiments may be adapted to any system comprising a network of measurement devices, each comprising a radio module and at least one environmental sensor different from the radio module, as soon as there is a relationship between the quality of the radio link and the quantity measured by the sensor.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A traffic or parking management system comprising:
a centralization unit; and
a plurality of vehicle detection devices, each device comprising a radio module capable of communicating with the centralization unit, and a sensor different from the radio module, capable of measuring a physical quantity representative of the presence or not of a vehicle in the vicinity of the device,
wherein each device is capable of adjusting at least one configuration parameter of its radio module by taking into account a measurement performed by its sensor.

2. The system of claim 1, where said at least one parameter is a parameter from the group comprising:
the transmit power of the radio module;
the receive sensitivity of the radio module;
the transmission rate of the radio module;
the transmit carrier frequency of the radio module;
the directivity of the antenna of the radio module; and
the routing path of communications between the radio module and the centralization unit.

3. The system of claim 1, wherein, in each device the sensor is a magnetic field sensor.

4. The system of claim 1, wherein each device is capable of performing said adjustment before the beginning of a phase of radio communication between the device and the centralization unit.

5. The system of claim 1, wherein, in each device the radio module has an adjustable transmit power.

6. The system of claim 1, wherein:
the network formed by the devices and the centralization unit has a topology such that there exists a plurality of possible communication routing paths between each device and the centralization unit; and
each device may be set to select a specific routing path for its communications with the centralization unit.

7. The system of claim 1, further comprising at least one repeater capable of relaying communications between a device and the centralization unit.

8. The system of claim 1, wherein each device comprises a unit for controlling its sensor and its radio module, and for processing the data provided by its sensor.

9. The system of claim 1, wherein each device comprises an electric battery for its power supply.

10. The system of claim 1, wherein each device is capable of deciding whether to postpone a radio communication by taking into account a measurement performed by its sensor.

11. The system of claim 1, wherein the devices are intended to be embedded in the ground, for example, under a roadway or under parking spaces.

12. A method of adjusting a radio module of a vehicle detection device comprising a radio module capable of communicating with a centralization unit external to the device, and a sensor different from the radio module capable of measuring a physical quantity representative of the presence or not of a vehicle in the vicinity of the device, this method comprising the steps of:
reading an output value of the sensor; and
adjusting at least one configuration parameter of the radio module by taking into account said output value of the sensor.

13. The method of claim 12, where said at least one parameter is a parameter from the group comprising:
the transmit power of the radio module;
the receive sensitivity of the radio module;
the transmission rate of the radio module;
the transmit carrier frequency of the radio module;
the directivity of the antenna of the radio module; and
the routing path of communications between the radio module and the centralization unit.
